(19) United States
(12) Patent Application Publication
(10) Pub. No.: US 2023/0406250 A1
(43) Pub. Date: Dec. 21, 2023

(54) VEHICLE FOR PROTECTING OCCUPANT AND OPERATING METHOD THEREOF

(71) Applicants: HYUNDAI MOTOR COMPANY, Seoul (KR); Kia Corporation, Seoul (KR)

(72) Inventors: Hyung Wook PARK, Seoul (KR); Joon Sang PARK, Hwaseong-si (KR); Sung Wook LEE, Seoul (KR)

(73) Assignees: HYUNDAI MOTOR COMPANY, Seoul (KR); Kia Corporation, Seoul (KR)

(21) Appl. No.: 18/199,468

(22) Filed: May 19, 2023

(30) Foreign Application Priority Data
May 19, 2022 (KR) 10-2022-0061419

(51) Int. Cl. B60R 21/015

(52) U.S. Cl. CPC B60R 21/01538; B60R 21/01558; B60R 21/01554

(57) ABSTRACT

A vehicle for protecting an occupant includes: a plurality of safe devices provided in the vehicle for protecting the occupant; first sensors configured to obtain information on a seat or the occupant within the vehicle; second sensors configured to detect a collision with other objects; and a processor which is operatively connected to the safe devices, the first sensors, and the second sensors. The processor is configured to obtain state information on at least one of the seat or the occupant based on the information obtained from the first sensors, to determine at least one safe device to be operated among the plurality of safe devices based on the state information on the at least one of the seat or the occupant, and to operate the determined at least one safe device when at least one of the second sensors detects a collision satisfying a predetermined condition.

### CROSS-REFERENCE TO RELATED APPLICATIONS

The present application claims priority to Korean Patent Application No. 10-2022-0061419, filed May 19, 2022, the entire contents of which is incorporated herein for all purposes by this reference.

### BACKGROUND OF THE PRESENT DISCLOSURE

### Field of the Present Disclosure

The present disclosure relates to a device that activates a safety device for protecting occupants in a vehicle and an operating method thereof.

### Description of Related Art

Recently, advanced driver assistance systems (ADAS) are being developed to assist the driving of a driver. The ADAS has multiple sub-classifications of technologies and provides convenience to the driver. Such ADAS is also called autonomous driving or automated driving system (ADS).

While the vehicle is autonomously driven through the ADS, occupants may do other things other than driving. Accordingly, a seat in a vehicle supporting autonomous driving may be rotatably provided so that the occupant is able to easily do other things. For example, a driver's seat of the vehicle supporting autonomous driving may be rotated toward the rear or the side of the vehicle rather than the front.

Meanwhile, the vehicle may be provided with a safety device such as an airbag and/or a pre-safe seat belt (PSB) to protect occupants and may operate the safety device when a collision occurs.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

As described above, as the driver's seat in the vehicle is freely rotatable, there may occur a situation where it is difficult to protect the occupant even if an airbag is operated to protect the occupant in a collision situation. For example, even if the vehicle detects the occurrence of a collision and deploys an airbag provided on the driver's seat side, when the driver's seat is rotated toward the rear of the vehicle, a situation where the occupant accommodated in the driver's seat cannot be protected may occur.

Accordingly, various aspects of the present disclosure are directed to providing a method and device configured for operating a safety device for occupant protection based on state information of the seat and/or an occupant in the vehicle.

Various embodiments of the present disclosure include a method and device configured for determining at least one of an operating method and an operating time point of the safety device by use of at least one sensor in the vehicle based on rotation state information of the seat and/or an occupant.

The technical problem to be overcome in the present specification is not limited to the above-mentioned technical problems. Other technical problems not mentioned may be clearly understood from those described below by a person having ordinary skill in the art.

An exemplary embodiment of the present disclosure is a vehicle for protecting an occupant. The vehicle includes: a plurality of safe devices provided in the vehicle for protecting the occupant; first sensors configured to obtain information on a seat or the occupant within the vehicle; second sensors configured to detect a collision with other objects; and a processor which is operatively connected to the safe devices, the first sensors, and the second sensors. The processor is configured to obtain state information on at least one of the seat or the occupant based on the information obtained from the first sensors, determines at least one safe device to be operated among the plurality of safe devices based on the state information on the at least one of the seat or the occupant, and operates the determined at least one safe device when at least one of the second sensors detects a collision satisfying a predetermined condition. The state information on the at least one of the seat or the occupant includes at least one of a rotation angle of the seat, a position of the seat, a tilt of the seat, a rotation angle of the occupant, a position of the occupant, and a tilt of the occupant.

The plurality of safe devices includes a plurality of airbags provided at different positions within the vehicle, and a plurality of pre-safe seat belts (PSBs) provided in different seats in the vehicle.

The processor is configured to determine an operation threshold of the at least one safety device to be operated based on the state information on the at least one of the seat or the occupant, compares an impact strength detected from at least one of the second sensors with the operation threshold, and operates the determined at least one safety device when the detected impact strength is greater than the operation threshold.

The first sensors include at least one of a sensor configured to detect the rotation angle of the seat, a sensor configured to detect the position of the seat, or a sensor configured to detect the tilt of the seat.

The first sensors include a camera configured to capture the occupant. The processor extracts three-dimensional (3D) human body keypoints from an image captured by the camera by use of an artificial neural network-based deep learning model, and obtains the state information on the occupant based on the extracted 3D human body keypoints.

The deep learning model is trained based on a new 3D body joint coordinate true which is generated by transforming a 3D body joint coordinate truth value.

The processor is configured to estimate a first rotation angle between a predetermined first reference line and a shoulder line in an x-y plane based on the 3D human body keypoints, and is configured to determine the first rotation angle as the rotation angle of the occupant. The predetermined first reference line is set parallel to the shoulder line when a body of the occupant faces a front of the vehicle.

The processor is configured to estimate a second rotation angle based on the 3D human body keypoints based on a width and a height of a body in a y-z plane, and is configured to determine the second rotation angle as the rotation angle of the occupant.

The processor is configured to estimate a first rotation angle between a predetermined first reference line and a shoulder line in an x-y plane based on the 3D human body keypoints, estimates a second rotation angle based on the 3D human body keypoints based on a width and a height of a body in a y-z plane, and is configured to determine the rotation angle of the occupant based on the first rotation angle and the second rotation angle.

The processor measures a distance to a keypoint corresponding to a predetermined body portion among the 3D human body keypoints, and is configured to determine the position of the occupant based on the measured distance.

The processor is configured to estimate an angle between a predetermined second reference line and a line connecting keypoints corresponding to a predetermined body portion among the 3D human body keypoints, and is configured to determine the estimated angle as the tilt of the occupant. The predetermined second reference line is perpendicular to the ground.

Another exemplary embodiment of the present disclosure is an operating method of a vehicle for protecting an occupant. The operating method includes: obtaining state information on at least one of a seat or the occupant within the vehicle based on information obtained from first sensors; determining at least one safe device to be operated among a plurality of safe devices provided in the vehicle based on the state information on the at least one of the seat or the occupant; and operating the determined at least one safe device when at least one of second sensors detects a collision satisfying a predetermined condition. The state information on the at least one of the seat or the occupant includes at least one of a rotation angle of the seat, a position of the seat, a tilt of the seat, a rotation angle of the occupant, a position of the occupant, and a tilt of the occupant.

The plurality of safe devices includes a plurality of airbags provided at different positions within the vehicle, and a plurality of pre-safe seat belts (PSBs) provided in different seats in the vehicle.

The operating the determined at least one safe device includes: comparing an impact strength detected from at least one of the second sensors with an operation threshold of the at least one safety device; and operating the determined at least one safety device when the detected impact strength is greater than the operation threshold of the at least one safety device. The operation threshold of the at least one safety device is determined based on the state information on the at least one of the seat or the occupant.

The first sensors include at least one of a sensor configured to detect the rotation angle of the seat, a sensor configured to detect the position of the seat, or a sensor configured to detect the tilt of the seat.

The first sensors include a camera configured to capture the occupant. The obtaining the state information on the at least one of the seat or the occupant includes: extracting three-dimensional (3D) human body keypoints from an image captured by the camera by use of an artificial neural network-based deep learning model; and
obtaining the state information on the occupant based on the extracted 3D human body keypoints.

The deep learning model is trained based on a new 3D body joint coordinate true which is generated by transforming a 3D body joint coordinate truth value.

The obtaining the state information on the occupant based on the extracted 3D human body keypoints includes: estimating a first rotation angle between a predetermined first reference line and a shoulder line in an x-y plane based on the 3D human body keypoints; and determining the first rotation angle as the rotation angle of the occupant. The predetermined first reference line is set parallel to the shoulder line when a body of the occupant faces a front of the vehicle.

The obtaining the state information on the occupant based on the extracted 3D human body keypoints includes: estimating a second rotation angle based on the 3D human body keypoints based on a width and a height of a body in a y-z plane; and determining the second rotation angle as the rotation angle of the occupant.

The obtaining the state information on the occupant based on the extracted 3D human body keypoints includes: estimating a first rotation angle between a predetermined first reference line and a shoulder line in an x-y plane based on the 3D human body keypoints; estimating a second rotation angle based on the 3D human body keypoints based on a width and a height of a body in a y-z plane; and determining the rotation angle of the occupant based on the first rotation angle and the second rotation angle.

The obtaining the state information on the occupant based on the extracted 3D human body keypoints includes: measuring a distance to a keypoint corresponding to a predetermined body portion among the 3D human body keypoints; and determining the position of the occupant based on the measured distance.

The obtaining the state information on the occupant based on the extracted 3D human body keypoints includes: estimating an angle between a predetermined second reference line and a line connecting keypoints corresponding to a predetermined body portion among the 3D human body keypoints; and determining the estimated angle as the tilt of the occupant. The predetermined second reference line is perpendicular to the ground.

According to various embodiments of the present disclosure, the vehicle operates the safety device for occupant protection based on state information of the seat and/or an occupant, safely protecting the occupant regardless of the state of the seat.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a vehicle according to various embodiments of the present disclosure;

FIG. 2 is a view showing in-vehicle components according to various embodiments of the present disclosure;

FIGS. 3A and 3B are views showing an airbag deployment method according to a state of a seat and/or an occupant in a vehicle according to various embodiments of the present disclosure;

FIG. 4 is a view showing that state information of the seat and/or the occupant is obtained by use of a deep learning network based on an indoor captured image in the vehicle according to various embodiments of the present disclosure;

FIG. 5A is a view showing a first learning method for the deep learning network according to various embodiments of the present disclosure;

FIG. 5B is a view showing a secondary learning method for the deep learning network according to various embodiments of the present disclosure;

FIG. 6 is a flowchart showing that a safety device is operated according to state information of the seat and/or the occupant in the vehicle according to various embodiments of the present disclosure;

FIG. 7A is a flowchart showing that a rotation angle of the seat and/or the occupant in the vehicle according to various embodiments of the present disclosure is determined;

FIG. 7B is a view showing that a shoulder line in an image captured in the vehicle according to various embodiments of the present disclosure is estimated;

FIG. 7C is a view showing a bounding box for a body in the image captured in the vehicle according to various embodiments of the present disclosure;

FIG. 8A is a flowchart showing that a position of the seat and/or the occupant in the vehicle according to various embodiments of the present disclosure is determined;

FIG. 8B is a view showing keypoints of body portions used for distance measurement in the vehicle according to various embodiments of the present disclosure;

FIG. 9A is a flowchart showing that a tilt of the seat and/or the occupant in the vehicle according to various embodiments of the present disclosure is determined; and

FIG. 9B is a view showing keypoints of body portions used for distance measurement in the vehicle according to various embodiments of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings. The same or similar elements will be denoted by the same reference numerals irrespective of drawing numbers, and repetitive descriptions thereof will be omitted.

A suffix “module” or “part” for the component, which is used in the following description, is provided or mixed in consideration of only convenience for ease of specification, and does not have any distinguishing meaning or function per se. Also, the “module” or “part” may mean software components or hardware components such as a field programmable gate array (FPGA), an application specific integrated circuit (ASIC). The “part” or “module” performs certain functions. However, the “part” or “module” is not meant to be limited to software or hardware. The “part” or “module” may be configured to be placed in an addressable storage medium or to restore one or more processors. Thus, for one example, the “part” or “module” may include components such as software components, object-oriented software components, class components, and task components, and may include processes, functions, attributes, procedures, subroutines, segments of a program code, drivers, firmware, microcode, circuits, data, databases, data structures, tables, arrays, and variables. Components and functions provided in the “part” or “module” may be combined with a smaller number of components and “parts” or “modules” or may be further divided into additional components and “parts” or “modules”.

Methods or algorithm steps described relative to various exemplary embodiments of the present disclosure may be directly implemented by hardware and software modules that are executed by a processor or may be directly implemented by a combination thereof. The software module may be resident on a RAM, a flash memory, a ROM, an EPROM, an EEPROM, a resistor, a hard disk, a removable disk, a CD-ROM, or any other type of record medium known to those skilled in the art. An exemplary record medium is coupled to a processor and the processor can read information from the record medium and can record the information in a storage medium. In another way, the record medium may be integrally formed with the processor. The processor and the record medium may be resident within an application specific integrated circuit (ASIC). The ASIC may be resident within a user's terminal.

Also, in the following description of the exemplary embodiment included in the present specification, the detailed description of known technologies incorporated herein is omitted to avoid making the subject matter of the exemplary embodiment included in the present specification unclear. Also, the accompanied drawings are provided only for more easily describing the exemplary embodiment included in the present specification. The technical spirit included in the present specification is not limited by the accompanying drawings. All modification, equivalents and substitutes included in the spirit and scope of the present disclosure are understood to be included in the accompanying drawings.

While terms including ordinal numbers such as the first and the second, etc., may be used to describe various components, the components are not limited by the terms mentioned above. The terms are used only for distinguishing between one component and other components.

In the case where a component is referred to as being “connected” or “accessed” to another component, it should be understood that not only the component is directly connected or accessed to the other component, but also there may exist another component between them. Meanwhile, in the case where a component is referred to as being “directly connected” or “directly accessed” to another component, it should be understood that there is no component therebetween.

Hereinafter, in an exemplary embodiment of the present disclosure, a vehicle is provided with an automated driving system (ADS) and thus may be autonomously driven. For example, the vehicle may perform at least one of steering, acceleration, deceleration, lane change, and stopping without a driver's manipulation by the ADS. The ADS may include, for example, at least one of pedestrian detection and collision mitigation system (PDCMS), lane change decision aid system (LCAS), land departure warning system (LDWS), adaptive cruise control (ACC), lane keeping assistance system (LKAS), road boundary departure prevention system (RBDPS), curve speed warning system (CSWS), forward vehicle collision warning system (FVCWS), and low speed following (LSF).

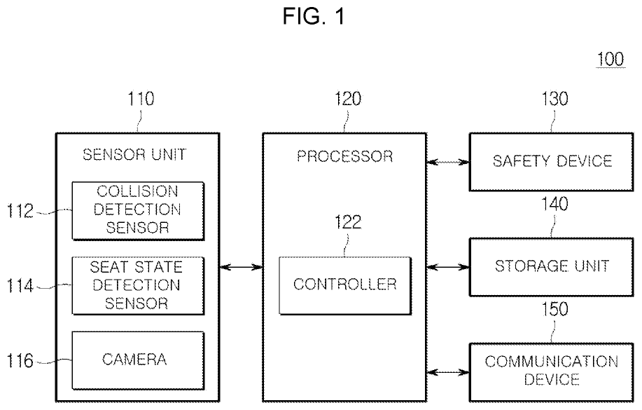

FIG. 1 is a block diagram of a vehicle according to various embodiments of the present disclosure.

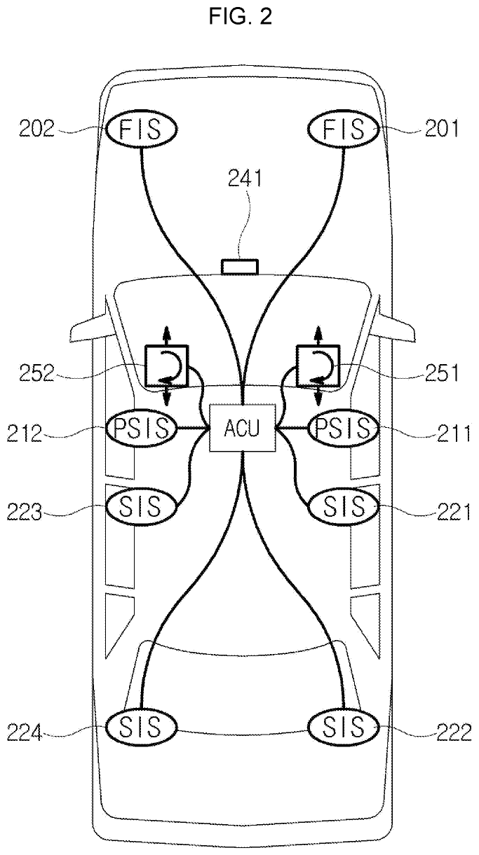

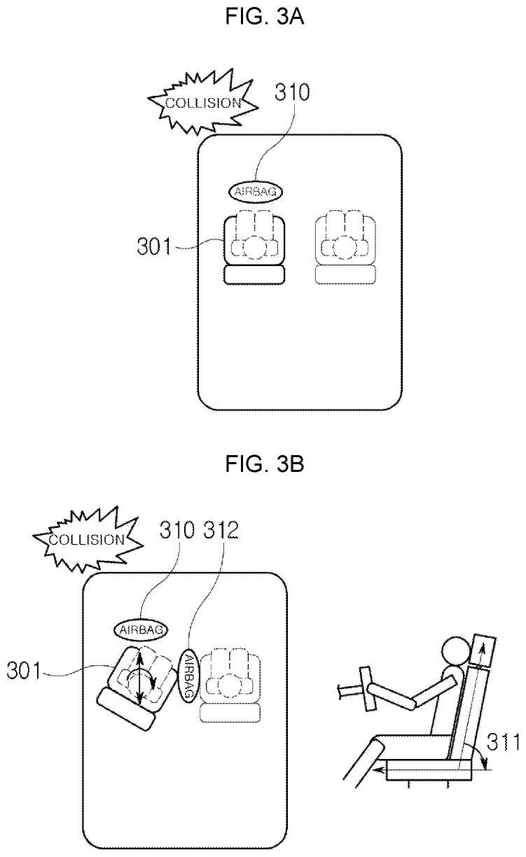

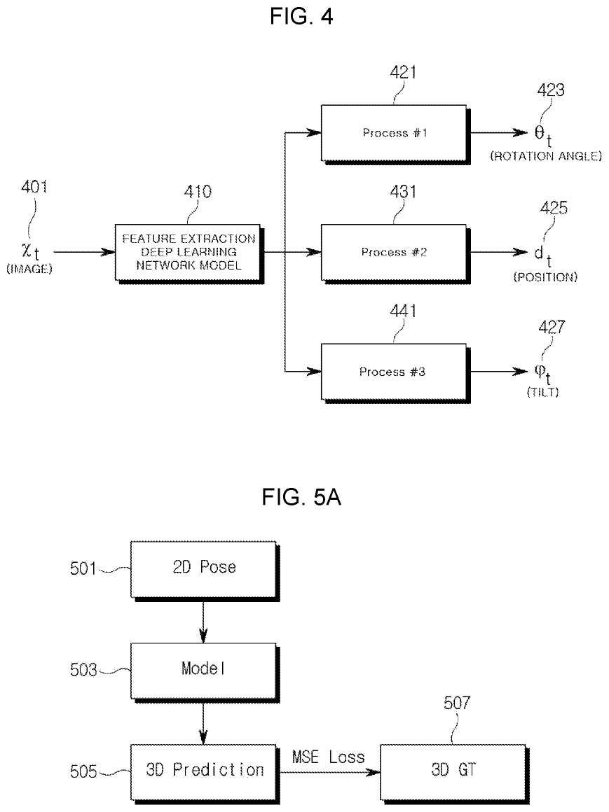

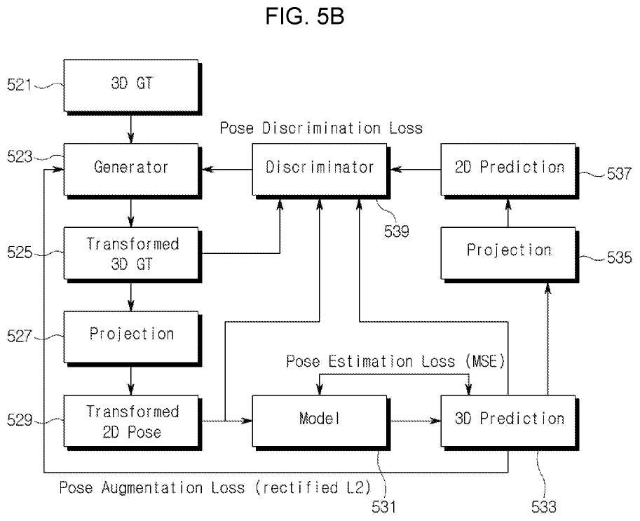

A vehicle shown in FIG. 1 is shown as an exemplary embodiment of the present disclosure. Each component of the electronic device may be configured with one chip, one part, or one electronic circuit or configured by combining chips, parts, and/or electronic circuits. According to the exemplary embodiment of the present disclosure, some of the components shown in FIG. 1 may be divided into a plurality of components and may be configured with different chips, parts or electronic circuits. Also, some components are combined and configured with one chip, one part, or one electronic circuit. According to the exemplary embodiment of the present disclosure, some of the components shown in FIG. 1 may be omitted or components not shown may be added. At least some of the components of FIG. 1 will be described with reference to FIG. 2, FIG. 3, FIG. 4 and FIG. 5B. FIG. 2 is a view showing in-vehicle components according to various embodiments of the present disclosure. FIGS. 3A and 3B are views showing an airbag deployment method according to a state of a seat and/or an occupant in a vehicle according to various embodiments of the present disclosure. FIG. 4 is a view showing that state information of the seat and/or the occupant is obtained by use of a deep learning network based on an indoor captured image in the vehicle according to various embodiments of the present disclosure. FIG. 5A is a view showing a first learning method for the deep learning network according to various embodiments of the present disclosure. FIG. 5B is a view showing a secondary learning method for the deep learning network according to various embodiments of the present disclosure.

Referring to FIG. 1, a vehicle 100 may include a sensor unit 110, a processor 120, a safety device 130, a storage unit 140, and a communication device 150.

According to various exemplary embodiments of the present disclosure, the sensor unit 110 may detect the internal and/or external environment of the vehicle 100 by use of a plurality of sensors, and may be configured to generate data related to the internal and/or external environment of the vehicle based on the detection result.

According to the exemplary embodiment of the present disclosure, the sensor unit 110 may include a collision detection sensor 112, a seat state detection sensor 114, and a camera 116.

The collision detection sensor 112 may detect a collision between the vehicle and an object (e.g., another vehicle, a pedestrian, an obstacle, etc.) and may be configured to generate a collision detection signal. For example, the collision detection sensor 112, as shown in FIG. 2, may include at least one of front impact sensors (FIS) 201 and 202, side impact sensors (SIS) 221 to 224, and pressure-type side impact sensor (PSIS) 211 and 212. The front impact sensors 201 and 202 may detect a front collision and may be configured to generate a signal indicating that a collision is detected at the front. The side impact sensors 221 to 224 may detect a side collision and may be configured to generate a signal indicating that a collision is detected at the side. Thereof. The pressure-type side impact sensors 211 and 212 may detect a side collision through pressure applied to the side of the vehicle and may be configured to generate a signal indicating that a collision due to pressure is detected at the side. Thereof. The collision detection signal may include at least one of information on an impact strength, a position where the collision is detected, and the sensor which is configured to detect the collision.

The seat state detection sensor 114 may measure state information on at least one seat in the vehicle and may be configured to generate the state information on the at least one seat. For example, the seat state detection sensor 114 may include, as shown in FIG. 2, sensors 251 and 252 that measure at least one of a rotation angle of the seat, a position of the seat, and a tilt of the seat in the vehicle. According to the exemplary embodiment of the present disclosure, the rotation angle of the seat, the position of the seat, and the tilt of the seat may be measured by different sensors or may be measured by the same sensor. The rotation angle of the seat may indicate how much the seat is rotated in a left or right direction based on when the seat faces the front of the vehicle. The position of the seat may indicate, for example, how much the corresponding seat in the vehicle is moved forward or backward from a specified reference position. The specified reference position may be set and/or changed by a designer. The specified reference position may be, for example, a position of a steering wheel, a position of a dashboard, or a basic position of the corresponding seat. However, the specified reference position is not limited thereto. The tilt of the seat may indicate the angle of the backrest of the seat.

The camera 116 may include at least one camera that obtains a vehicle interior image by capturing. The vehicle interior image may be an image obtained by capturing an occupant withing the vehicle. To capture the occupant, the camera 116 may be, as shown in FIG. 2, provided in an area 241 where a rearview mirror of the vehicle is provided. The disposition location of the camera 116 for obtaining the vehicle interior image is only an example, and various embodiments of the present disclosure are not limited thereto. For example, the camera 116 may be provided at any position within the vehicle where it is possible to capture the occupant within the vehicle.

The sensor unit 110 may further include at least one other sensor in addition to the above-described sensors. For example, the sensor unit 110 may further include at least one of a camera that captures the environment outside the vehicle, a radio detection and ranging (RADAR) and a light detection and ranging (LIDAR) that detect an object around the vehicle, or a position measuring sensor configured for measuring that is configured to measure the position of the vehicle. The listed sensors are only examples for understanding, and the sensors of the present disclosure are not limited thereto.

The processor 120 may control the overall operation of the vehicle 100. According to the exemplary embodiment of the present disclosure, the processor 120 may include an electrical control unit (ECU) configured for integrally controlling the components within the vehicle 100. For example, the processor 120 may include a central processing unit (CPU) or micro processing unit (MCU) configured for performing arithmetic processing. According to the exemplary embodiment of the present disclosure, the processor 120 may include an airbag control unit (ACU) 231 that is configured to control the airbag which is a safety device.

According to various exemplary embodiments of the present disclosure, based on the state information of the seat and/or the occupant within the vehicle, the processor 120 may be configured to determine at least one safety device 130 to be operated and may control the operation of the determined safety device 130. The state information of the seat and/or the occupant may include at least one of a rotation angle θₜ, a position dₜ, and a tilt φₜ of the seat and/or the occupant. The safety device 130 may include at least one of an airbag and a pre-safe seat belt (PSB). For example, when the state information of the seat and/or the occupant indicates that the occupant is facing the front of the vehicle, the processor 120 may, as shown in FIG. 3A, control so that a front airbag 310 in front of the seat of the corresponding occupant is deployed. For another example, when the state information of the seat and/or the occupant indicates that the occupant has been rotated toward the right side of the vehicle, the processor 120 may, as shown in FIG. 3B, control so that the front airbag 310 in front of the seat of the corresponding occupant and a center airbag 312 positioned on the right side are deployed.

According to the exemplary embodiment of the present disclosure, when a specified event is detected, the processor 120 may be configured to determine a safety device operation threshold. The specified event may include at least one of an event in which the collision detection signal is input from the sensor unit 110, an event in which a collision with a nearby object is predicted based on detecting data of the sensor unit 110, and an event at which a collision prediction time point arrives. The listed specified events are merely examples for understanding, and various embodiments of the present disclosure are not limited thereto. When the specified event is detected, the processor 120 may obtain vehicle state information and may be configured to determine the safety device operation threshold to control an operating time point of the safety device 130 based on the obtained vehicle state information. The vehicle state information may include, for example, at least one of a vehicle speed, steering, or a yaw rate. For example, the processor 120 may select a safety device operation threshold corresponding to the speed, steering, and/or yaw rate of the current vehicle from among the safety device operation thresholds preset for airbag deployment.

According to the exemplary embodiment of the present disclosure, the processor 120 may obtain the state information of the seat and/or the occupant from the detecting data obtained from the seat state detection sensor 114 or image data obtained from the camera 116.

According to the exemplary embodiment of the present disclosure, when an image recognition function for the image obtained from the camera 116 does not operate normally, the processor 120 may obtain the state information of the seat from the seat state detection sensor 114. For example, when the camera 116 operates abnormally or a recognition error occurs on the image obtained from the camera 116, the processor 120 may obtain at least one of the rotation angle θₜ of the seat, the position dₜ of the seat, and the tilt φₜ of the seat from the seat state detection sensor 114.

According to the exemplary embodiment of the present disclosure, when the image recognition function for the image obtained from the camera 116 operates normally, the processor 120 inputs the image data obtained from the camera 116 to a pre-trained deep learning model, obtaining the state information of the occupant. The state information of the occupant may obtain at least one of the rotation angle θₜ of the occupant, the position dₜ of the occupant, or the tilt φₜ of the occupant. The tilt of the occupant may indicate the tilt of the upper body of the occupant. The rotation angle of the occupant may indicate, for example, how much the occupant is rotated in the right direction based on when the occupant faces the front of the vehicle. The rotation angle of the occupant may be represented by any one of a plurality of previously separated stages. For example, the rotation angle of the occupant may be represented by any one of a first stage (rotation between about −30 degrees and +30 degrees), a second stage (rotation between about +30 degrees and +90 degrees), a third stage (rotation between about +90 degrees and +150 degrees), a fourth stage (rotation between about +150 degrees and +180 degrees or rotation between about −150 degrees and −180 degrees), a fifth stage (rotation between about −90 degrees and −150 degrees), and a sixth stage (rotation between about −30 degrees and −90 degrees). The position of the occupant may indicate, for example, how much the occupant is moved forward or backward from the specified reference position and/or the direction of movement (e.g., front, normal, or backward). For example, the position of the occupant may be represented by distinguishing whether the occupant is in front of the reference position, in the reference position, or behind the reference position. The reference position may be set and/or changed by a designer. The tilt of the occupant may indicate the tilt of the upper body of the occupant. The tilt of the upper body of the occupant may indicate an angle formed by the upper body with respect to the ground, a plane parallel to the ground, or the floor surface of the vehicle. The tilt of the upper body of the occupant may be represented by any one of a plurality of previously separated stages. For example, the tilt of the upper body of the occupant may be represented by any one of a first stage (tilt between about 60 degrees and 69 degrees), a second stage (tilt between about 70 degrees and 79 degrees), a third stage (tilt between about 80 degrees and 89 degrees), and a fourth stage (tilt between about 90 degrees and 99 degrees).

The processor 120 may obtain, as shown in FIG. 4, the rotation angle θₜ 423, the position dₜ 425, and the tilt φₜ 427 of the occupant based on a pre-trained feature extraction deep learning network model 410 that utilizes an image as an input. For example, the processor 120 may extract the features of the occupant included in an input image xₜ 401 by use of the feature extraction deep learning network model 410, and may obtain the rotation angle 423 of the occupant by performing a specified first process (Process #1) 421 based on the extracted features. Also, the processor 120 may obtain the position 425 and the tilt 427 of the occupant by performing a specified second process (Process #2) 425 and a third processor process (Process #3) 427 based on the features extracted from the feature extraction deep learning network model 410. According to the exemplary embodiment of the present disclosure, the feature extraction deep learning network model 410 is an artificial neural network-based deep learning model and may be an open-source network model configured for extracting human body keypoints, such as CoCo or MobileNet. The human body keypoints may include body joint coordinates.

According to the exemplary embodiment of the present disclosure, the feature extraction deep learning network model 410 may, as shown in FIG. 5A, use a first trained model (Model) 503 through pre-training. For example, a two-dimensional (2D) pose part (2D Pose) 501 may obtain a front view image including a 2D pose from an image data of an open-source network and may obtain 2D body joint coordinates from the front view image. The model 503 may predict three-dimensional (3D) body joint coordinates by use of the 2D body joint coordinates. The 3D body joint coordinates (3D Prediction) 505 predicted by the model 503 are compared with a 3D body joint coordinate truth value (3D ground truth (GT)) 507, so that the model 503 may be trained to minimize the error. For example, the feature extraction deep learning network model 410 may be trained so that a mean squared error (MSE) between the 3D body joint coordinates 505 and the 3D body joint coordinate truth value 507 is minimized.

According to the exemplary embodiment of the present disclosure, the feature extraction deep learning network model 410 may use a secondary trained model 531. The secondary trained model may be, as shown in FIG. 5B, trained through generative adversarial augmentation training. For example, as shown in FIG. 5A, the model 503 trained first through pre-training may be, as shown in FIG. 5B, secondary trained. As shown in FIG. 5B, a generator (Generator) 523 may transform a 3D body joint coordinate truth value (3D GT) 521 and may be configured to generate the transformed 3D body joint coordinate truth value. The transformed 3D body joint coordinate true value (Transformed 3D GT) 525 output from the generator 523 may be provided to a projection unit (Projection) 527 and a discriminator (Discriminator) 539. The projection unit 527 may obtain a transformed 2D body joint coordinates (Transformed 2D Pose) 529 corresponding to a 2D pose transformed by projecting the transformed 3D body joint coordinate true value 525. The transformed 2D body joint coordinates 529 may be provided to the model 531 and the discriminator 539. The model 531 may be configured to predict the 3D body joint coordinates by use of the transformed 2D body joint coordinates. The 3D body joint coordinates (3D Prediction) 533 predicted by the model 531 are compared with the transformed 3D body joint coordinate true value 525 generated by the generator 523, and the model 531 may be trained so that the comparison result error is minimized. For example, the model 531 may be trained so that a pose estimation loss (MSE) which means a difference between the 3D body joint coordinates predicted by the model and the transformed 3D body joint coordinate truth value may be minimized. Furthermore, to improve the ease and efficiency of training the model 531, a pose augmentation loss (rectified L2) generated based on the predicted 3D body joint coordinates 533 may be provided to the generator 523. For example, to easily or efficiently train the model 531, it is better to promote the model learning with augmented data rather than existing data, for example, data amplified/generated by use of previously obtained existing data. That is, it is desirable to train by generating X′ where Lp(X′)>Lp(X). Here, X′ may be generated by use of L=|1−exp(Lp(X′)−β·Lp(X)|.

A projection unit (Prediction) 535 may obtain a 2D body joint coordinates 537 corresponding to a 2D pose by projecting the 3D body joint coordinates 533 predicted by the model 531 and may provide the 2D body joint coordinates 537 to the discriminator 539. The discriminator 539 may compare whether the 2D body joint coordinates 537 that are the result predicted by the model 531 are the same as the transformed 2D body joint coordinates 529, and may compare the transformed 3D body joint coordinate true value 525 and the 3D body joint coordinates 533 predicted by the model 531, and then may provide the results to the generator 523.

The generator 523 may be configured to generate a new transformed 3D body joint coordinate true value based on the result provided from the discriminator 539. According to the exemplary embodiment of the present disclosure, when it is determined that at least one of the two comparison results received from the discriminator 539 represents that they are not the same, the generator 523 is configured to determine the training as not having been completed, and thus, may be configured to generate a new transformed 3D body joint coordinate true value. Conversely, when it is determined that at least one of the two comparison results received from the discriminator 539 represents that they are the same, the generator 523 is configured to determine the training of the model 531 as having been completed, and thus, may terminate the training without generating an additional transformed 3D body joint coordinate true value. Here, the meaning of what they are same is that a difference between the 3D body joint coordinates 533 predicted by the model 531 and the transformed 3D body joint coordinate true value 525 is within a predetermined value, or is that a difference between the 2D body joint coordinates 537 that are the result predicted by the model 531 and the transformed 2D body joint coordinates 529 is within a predetermined value.

As an additional transformation, the generator 523 may limit the transformed 3D body joint coordinate true value 525 which may be generated based on one 3D body joint coordinate truth value 521 to a predetermined value. According to the exemplary embodiment of the present disclosure, when the generator 523 intends to generate an additionally transformed 3D body joint coordinate true value 525 based on the comparison result of the discriminator 539, if the generator 523 generates already the transformed 3D body joint coordinate true value 525 by a predetermined value, the generator 523 transforms the 3D body joint coordinate truth value 521 used as an original, and then may be configured to generate an additional transformed 3D body joint coordinate true value 525.

In various embodiments of the present disclosure, it is possible to improve the performance of the feature extraction deep learning network model by generating a lot of learning data by only limited image data through the generative adversarial augmentation training described above.

According to the exemplary embodiment of the present disclosure, the feature extraction deep learning network model 410 may be trained by use of at least one of the learning methods shown in FIG. 5A and FIG. 5B.

According to the exemplary embodiment of the present disclosure, the feature extraction deep learning network model 410 may be pre-trained in an external server or the like before being mounted in the vehicle, by use of at least one of the learning methods shown in FIG. 5A and FIG. 5B.

According to the exemplary embodiment of the present disclosure, the processor 120 may update the safety device operation threshold in accordance with the state information of the seat and/or the occupant. The processor 120 may update the safety device operation threshold so that a preset safety device combination corresponding to the combination of the rotation angle, the position, and the tilt of the seat and/or the occupant is operated at a preset operating time. The operating time and the safety device combination corresponding to the combination of the rotation angle, the position, and the tilt of the seat and/or the occupant may be set in advance through a collision analysis or a sled test for each combination of the rotation angle, the position, and the tilt of the seat and/or the occupant. For example, if the rotation angle, the position, and the tilt are in the “first stage (rotation between about −30 degrees and +30 degrees), normal, the fourth stage (tilt between about 90 degrees and 99 degrees)”, the safety device combination may be determined as “driver's seat airbag” and the operating time may be determined as a case where “the impact strength is greater than or equal to a predetermined threshold value+α” through the collision analysis or sled test. The processor 120 may update the safety device operation threshold to a value which is greater than the predetermined safety device operation threshold by a. For another example, when the rotation angle, the position, and the tilt are in the “third stage (rotation between about +90 degrees and +150 degrees), front, the fourth stage (tilt between about 90 degrees and 99 degrees)”, the safety device combination may be determined as “driver's seat airbag and center airbag” and the operating time may be determined as a case where “the impact strength is greater than or equal to a predetermined threshold value+β” through the collision analysis or sled test. The processor 120 may update the safety device operation threshold to a value which is greater than the predetermined safety device operation threshold by β. According to the exemplary embodiment of the present disclosure, when the safety device combination is determined, a position where the collision is detected and whether an occupant is accommodated in each seat may be additionally taken into consideration.

According to the exemplary embodiment of the present disclosure, when an impact strength greater than the updated safety device operation threshold is detected, the processor 120 may operate at least one safety device in accordance with the safety device combination corresponding to the state information of the seat and/or the occupant. The impact strength may be obtained from the collision detection signal of the collision detection sensor 112.

According to the exemplary embodiment of the present disclosure, the processor 120 may include a controller 122 which is configured to control the operation of at least one component included in the vehicle and/or at least one function of the vehicle. The controller 122 may operate at least one safety device corresponding to the safety device combination determined based on the state information of the seat and/or the occupant among various safety devices included in the vehicle. For example, when the safety device combination determined according to the state information of the seat and/or the occupant is “driver's seat airbag”, the controller 122 may control the driver's seat airbag to be deployed. For another example, when the safety device combination determined according to the state information of the seat and/or the occupant is “driver's seat airbag, center airbag and PSB”, the controller 122 may control the PSB to operate while controlling the driver's seat airbag and center airbag to be deployed.

The safety device 130 may include safety devices for protecting occupants. For example, the safety device 130 may include a plurality of airbags and/or a plurality of PSBs. The plurality of airbags may be provided at different positions within the vehicle respectively. The plurality of PSBs may be provided in different seats in the vehicle respectively.

The storage unit 140 may store various programs and data for the operation of the vehicle and/or the processor 120. According to the exemplary embodiment of the present disclosure, the storage unit 140 may store various programs and data required to operate the safety device according to the state information of the seat and/or the occupant. For example, the storage unit 140 may store information on the safety device combination corresponding to each combination of the rotation angle, the position, and the tilt of the seat and/or the occupant. The storage unit 140 may store information on the safety device operation threshold corresponding to each combination of the rotation angle, the position, and the tilt of the seat and/or the occupant, and/or information on the amount of the update of the safety device operation threshold.

The communication device 150 may communicate with an external device of the vehicle 100. According to various exemplary embodiments of the present disclosure, the communication device 150 may receive data from the outside of the vehicle 100 or transmit data to the outside of the vehicle 100 under the control of the processor 120. For example, the communication device 150 may perform a communication by use of a wireless communication protocol or a wired communication protocol.

The foregoing description has described a method for controlling the operation of the safety device 130 by use of the seat state information obtained through the seat state detection sensor 114 or by use of the occupant state information obtained through the camera 116. However, according to various exemplary embodiments of the present disclosure, the operation of the safety device 130 can also be controlled by use of the seat state information and the occupant state information.

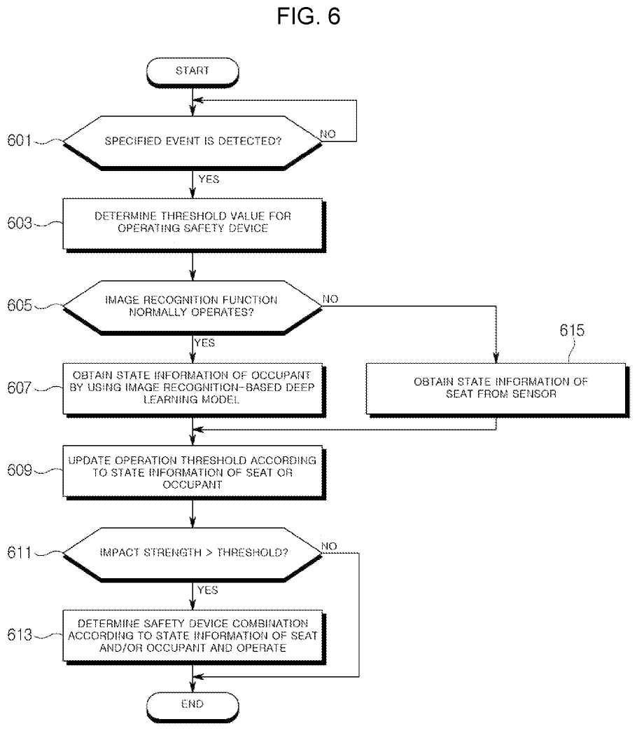

FIG. 6 is a flowchart showing that the safety device is operated according to the state information of the seat and/or the occupant in the vehicle according to various embodiments of the present disclosure. In the following embodiment, respective steps may be sequentially performed, and may not be necessarily performed sequentially. For example, the order of the respective steps may be changed, and at least two steps may be performed in parallel. Furthermore, the following steps may be performed by the processor 120 and/or at least one other component (e.g., the sensor unit 110) included in the vehicle 100, or may be implemented with instructions which may be executed by the processor 120 and/or the at least one other component (e.g., the sensor unit 110).

Referring to FIG. 6, in step 601, the vehicle 100 may be configured to determine whether a specified event is detected. The specified event may include at least one of an event in which the collision detection signal is input from the sensor unit 110, an event in which a collision with a nearby object is predicted based on the detecting data of the sensor unit 110, and an event at which the collision prediction time point arrives. The listed specified events are merely examples for understanding, and various embodiments of the present disclosure are not limited thereto.

When the specified event is detected, the vehicle 100 may be configured to determine a threshold value for operating the safety device in step 603. According to the exemplary embodiment of the present disclosure, when the specified event is detected, the vehicle 100 may be configured to determine the safety device operation threshold for controlling the operation timing of the safety device 130 based on the vehicle state information (e.g., vehicle speed, steering, and/or yaw rate). For example, the vehicle 100 may select and determine the safety device operation threshold corresponding to information on the current vehicle state from among pre-stored safety device operation thresholds for each vehicle state. For another example, the vehicle 100 may be configured to determine the threshold value for operating the safety device based on a function which has at least one of the vehicle speed, steering, and yaw rate as an input variable and outputs the safety device operation threshold through a specified operation.

In step 605, the vehicle 100 may be configured to determine whether the image recognition function normally operates. For example, the vehicle 100 may be configured to determine whether the image recognition function for an indoor captured image obtained through the in-vehicle camera 116 normally operates. When the camera 116 for obtaining the indoor captured image does not operate normally or an image recognition error for the indoor captured image is detected, the vehicle 100 may be configured to determine the image recognition function as not operating normally.

When the image recognition function does not operate normally, the vehicle 100 may obtain the state information of the seat from the sensors provided in the vehicle in step 615. For example, the vehicle 100 may obtain at least one of the rotation angle θₜ of the seat, the position dₜ of the seat, and the tilt φₜ of the seat from the seat state detection sensor 114 provided in the vehicle.

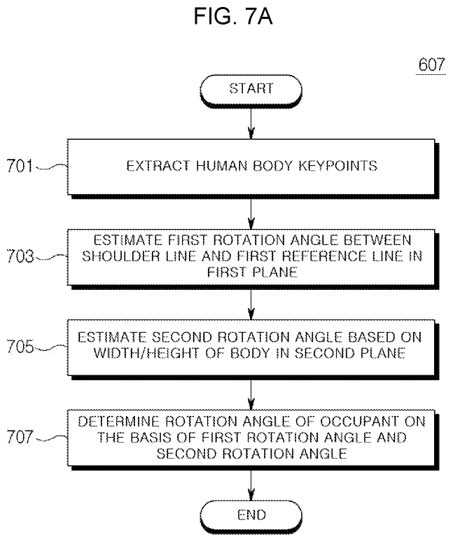

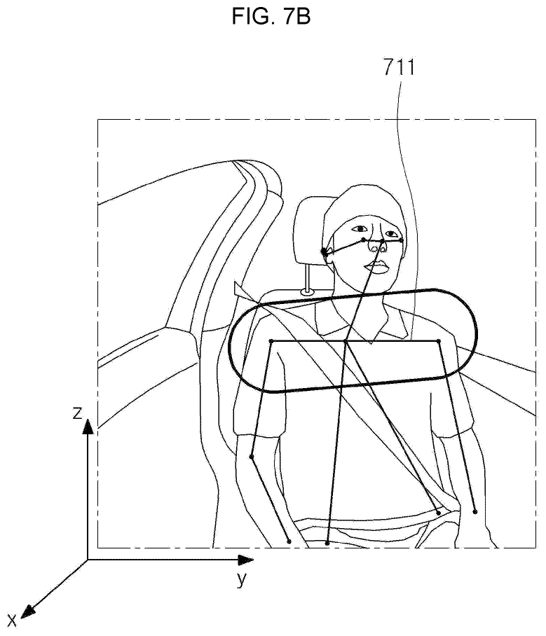

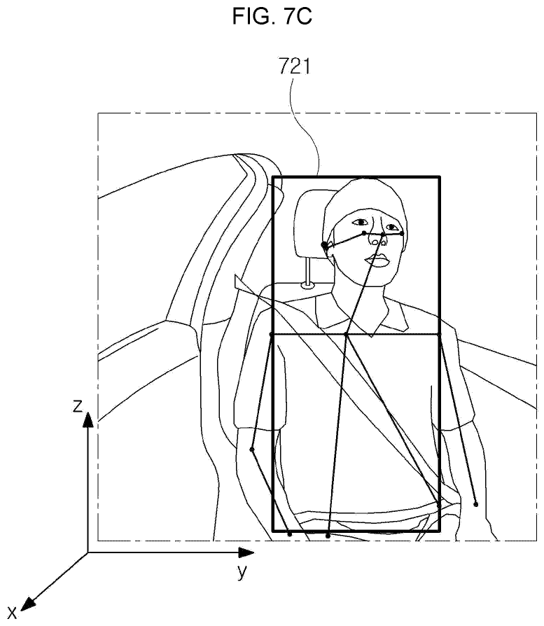

When the image recognition function operates normally, the vehicle 100 may obtain the state information of the occupant in step 607 by use of an image recognition-based deep learning model. For example, the vehicle 100 may obtain the state information of the occupant by inputting the indoor captured image obtained from the camera 116 to a pre-trained deep learning model. The state information of the occupant may obtain at least one of the rotation angle θₜ of the occupant, the position dₜ of the occupant, and the tilt φₜ of the occupant. The image recognition-based deep learning model may include the feature extraction deep learning network model 410 that extracts keypoints related to the body of the occupant from the image. The feature extraction deep learning network model 410 may be pre-trained as shown in FIG. 5A and FIG. 5B. A method for obtaining the state information of the occupant will be described in more detail with reference to FIGS. 7A to 9B to be described later.

In step 609, the vehicle 100 may update the safety device operation threshold according to the state information of the seat or the occupant. According to the exemplary embodiment of the present disclosure, the vehicle 100 may update the safety device operation threshold so that at least one safety device is operated at a preset operating time in accordance with the combination of the rotation angle, the position, and the tilt of the seat and/or the occupant. For example, the vehicle 100 may update the safety device operation threshold by adding the amount of the update of the threshold according to the combination of the rotation angle, the position, and the tilt of the seat and/or the occupant to the safety device operation threshold determined in step 603. According to the exemplary embodiment of the present disclosure, for each combination of the rotation angle, the position, and the tilt of the seat and/or the occupant, the amount of the update of the threshold corresponding to each combination may be stored in a form of a table. According to the exemplary embodiment of the present disclosure, the vehicle 100 may update the safety device operation threshold based on a specified function which has at least one of the rotation angle, the position, and the tilt as an input variable and outputs the amount of the update of the threshold through a specified operation.

In step 611, the vehicle 100 may be configured to determine whether the impact strength is greater than the updated safety device operation threshold. For example, the vehicle 100 may check the impact strength based on the collision detection signal obtained from the collision detection sensor 112 and may compare the checked impact strength with the safety device operation threshold.

When the impact strength is greater than the updated safety device operation threshold, the vehicle 100 may determine, in step 613, the combination of the safety devices to be operated according to the state information of the seat or the occupant, and may operate the safety devices corresponding to the determined safety device combination. When the impact strength is greater than the updated safety device operation threshold, the vehicle 100 may be configured to determine that the safety device needs to be operated and may be configured to determine the combination of the safety devices to be operated based on the state information of the seat or the occupant. The safety device combination corresponding to the state information of the seat or the occupant may be set in advance and stored in the storage unit 140 of the vehicle in a form of a table. For example, if the rotation angle, the position, and the tilt of the occupant are in the “first stage (rotation between about −30 degrees and +30 degrees), normal, the fourth stage (tilt between about 90 degrees and 99 degrees)”, the combination of the safety devices to be operated may be determined as “driver's seat airbag” by the vehicle 100 based on the table stored in the storage 140, and the driver's seat airbag may be deployed. For another example, if the rotation angle, the position, and the tilt of the occupant are in the “third stage (rotation between about +90 degrees and +150 degrees), front, the fourth stage (tilt between about 90 degrees and 99 degrees)”, the combination of the safety devices to be operated may be determined as “driver's seat airbag and center airbag” by the vehicle 100 based on the table stored in the storage 140, and the driver's seat airbag and the center airbag may be deployed.

FIG. 7A is a flowchart showing that the rotation angle of the seat and/or the occupant in the vehicle according to various embodiments of the present disclosure is determined. At least some steps of FIG. 7A may be included in step 607 of FIG. 6 or may be included in the first process (Process #1) 421 described in FIG. 1. Hereinafter, the respective steps of FIG. 7A may be sequentially performed, and may not be necessarily performed sequentially. Hereinafter, at least some steps of FIG. 7A will be described with reference to FIGS. 7B and/or 7C. FIG. 7B is a view showing that a shoulder line in the image captured in the vehicle according to various embodiments of the present disclosure is estimated. FIG. 7C is a view showing a bounding box for a body in the image captured in the vehicle according to various embodiments of the present disclosure.

Referring to FIG. 7A, in step 701, the vehicle 100 may extract human body keypoints from the images obtained from the in-vehicle camera 116. According to the exemplary embodiment of the present disclosure, the vehicle 100 may extract human body keypoints from the image by use of the feature extraction deep learning network model 410 shown in FIG. 4. The human body keypoints may include the 3D body joint coordinates.

In step 703, the vehicle 100 may estimate a first rotation angle between a shoulder line and a first reference line in a first plane. For example, the vehicle 100 may estimate the shoulder line of the occupant in the first plane (x-y plane) based on 3D human body keypoints and may estimate the rotation angle between the estimated shoulder line and the first reference line. When the body of the occupant faces the front of the vehicle, which is to say, when the body of the occupant does not rotate, the first reference line may be set as a line parallel to the shoulder line. According to the exemplary embodiment of the present disclosure, the shoulder line of the occupant may be obtained based on two keypoints corresponding to both shoulder joints among the human body keypoints estimated in step 701. For example, as shown in FIG. 7B, the shoulder line 711 of the occupant may be determined by a line connecting two keypoints corresponding to both shoulder joints.

In step 705, the vehicle 100 may estimate a second rotation angle based on the width/height of the body in a second plane. For example, the vehicle 100 may estimate the body of the occupant in the second plane (y-z plane) based on the 3D human body keypoints and may estimate a width and a height of a bounding box with respect to the estimated body. The vehicle 100 may estimate the rotation angle of the occupant based on the width and height of the bounding box with respect to the body. For example, when the occupant rotates from the front to the left or from the front to the right, the heights of the bounding boxes for continuously input second images are all the same, and the widths may gradually taper. Conversely, when the occupant returns to the front from the state where the occupant has rotated to the right or returns to the front from the state where the occupant has rotated to the left, the heights of the bounding boxes for the continuously input second images are all the same, and the widths may gradually increase. Accordingly, the vehicle 100 may be configured to determine the rotation angle of the occupant based on a ratio of the height to the width of the bounding box. According to the exemplary embodiment of the present disclosure, as shown in FIG. 7B, the bounding box 721 may be formed to be a 2D box in the y-z plane which includes at least one of the head, shoulder, and hip without including the arm. This is only an example, and various embodiments of the present disclosure are not limited thereto.

In step 707, the vehicle 100 may be configured to determine the rotation angle of the occupant based on the first rotation angle and the second rotation angle. For example, the vehicle 100 may be configured to determine an average of the first rotation angle estimated in step 703 and the second rotation angle estimated in step 705 as the rotation angle of the occupant. For example, the vehicle 100 may add the first rotation angle and the second rotation angle and may be configured to determine the result obtained by dividing the added value by 2 as the rotation angle of the occupant.

The average of the first rotation angle and the second rotation angle is determined as the rotation angle of the occupant in FIG. 7A described above. However, according to various exemplary embodiments of the present disclosure, the first rotation angle may be determined as the rotation angle of the occupant or the second rotation angle may be determined as the rotation angle of the occupant.

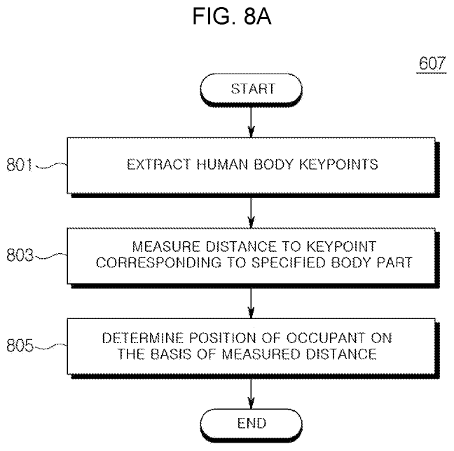

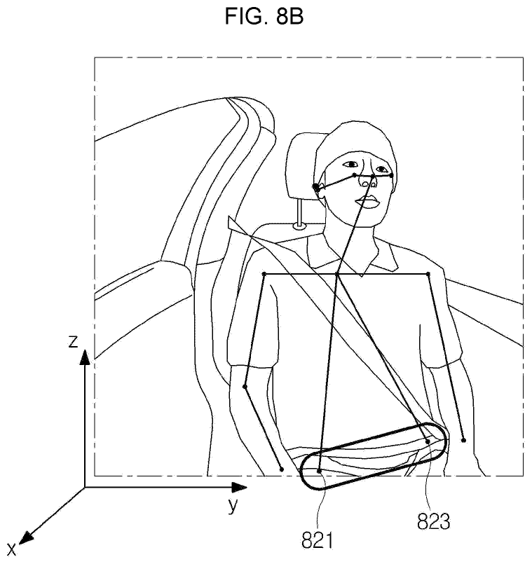

FIG. 8A is a flowchart showing that the position of the seat and/or the occupant in the vehicle according to various embodiments of the present disclosure is determined. At least some steps of FIG. 8A may be included in step 607 of FIG. 6 or may be included in the second process (Process #2) 431 described in FIG. 1. Hereinafter, the respective steps of FIG. 8A may be sequentially performed, and may not be necessarily performed sequentially. According to the exemplary embodiment of the present disclosure, at least one step of FIG. 8A may be performed at least temporarily at the same time with at least one step of FIG. 7A. For example, FIGS. 7A and 8A may be performed in parallel. Hereinafter, at least some steps of FIG. 8A will be described with reference to FIG. 8B. FIG. 8B is a view showing keypoints of body portions used for distance measurement in the vehicle according to various embodiments of the present disclosure.

Referring to FIG. 8A, in step 801, the vehicle 100 may extract human body keypoints from the images obtained from the in-vehicle camera 116. As described in FIG. 7A, the human body keypoints may be extracted by use of the feature extraction deep learning network model 410 of FIG. 4.

In step 803, the vehicle 100 may measure a distance to the keypoint corresponding to a specified body portion. For example, the vehicle 100 may check the coordinates of a specified body portion (e.g., hip) in the 3D body joint coordinates and may measure an x-axis distance to the coordinates of the body portion in the coordinate axis. One or two keypoints of the hip may be extracted from the 3D body joint coordinates. As shown in FIG. 8B, when two hip keypoints 821 and 823 are included in the 3D body joint coordinates, the vehicle 100 may be configured to determine a center point of the two keypoints 821 and 823 and may measure the x-axis distance to the determined center portion point. When one hip keypoint is included in the 3D body joint coordinates, the vehicle 100 may measure the x-axis distance to the one keypoint.

In step 805, the vehicle 100 may be configured to determine the position of the occupant based on the measured distance. According to the exemplary embodiment of the present disclosure, the vehicle 100 may compare the measured distance and a specified distance and may be configured to determine whether the occupant is located in front of or behind the specified reference position. The specified distance may be set as the x-axis distance to the specified reference position in the coordinate axis. For example, when the measured distance is greater than the specified distance, the vehicle 100 may be configured to determine the occupant as being located behind the reference position. For another example, when the measured distance is smaller than the specified distance, the vehicle 100 may be configured to determine the occupant as being located in front of the reference position. When the measured distance and the specified distance are the same, the vehicle 100 may be configured to determine the occupant as being located at the specified reference position.

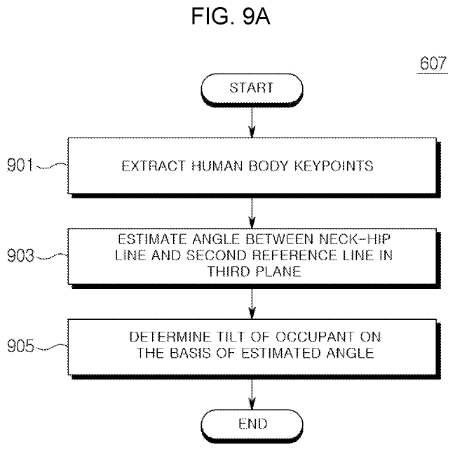

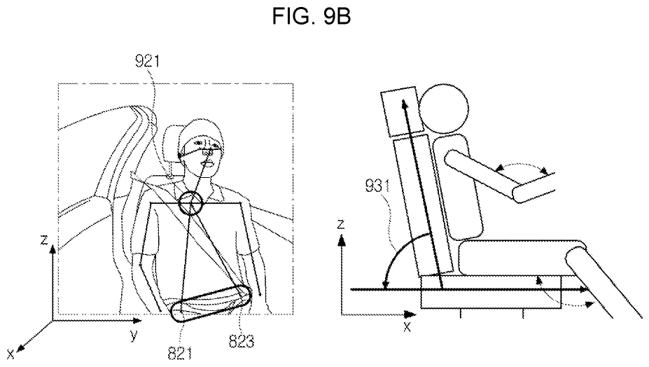

FIG. 9A is a flowchart showing that the tilt of the seat and/or the occupant in the vehicle according to various embodiments of the present disclosure is determined. At least some steps of FIG. 9A may be included in step 607 of FIG. 6 or may be included in the third process (Process #3) 441 described in FIG. 1. Hereinafter, the respective steps of FIG. 9A may be sequentially performed, and may not be necessarily performed sequentially. According to the exemplary embodiment of the present disclosure, at least one step of FIG. 9A may be performed at least temporarily at the same time with at least one step of FIG. 7A and/or FIG. 8A. For example, FIGS. 7A, 8A, and 9A may be performed in parallel. Hereinafter, at least some steps of FIG. 9A will be described with reference to FIG. 9B. FIG. 9B is a view showing the keypoints of body portions used for distance measurement in the vehicle according to various embodiments of the present disclosure.

Referring to FIG. 9A, in step 901, the vehicle 100 may extract human body keypoints from the images obtained from the in-vehicle camera 116. As described in FIG. 7A, the human body keypoints may be extracted by use of the feature extraction deep learning network model 410 of FIG. 4.

In step 903, the vehicle 100 may estimate an angle between a neck-hip line and a second reference line in a third plane. For example, the vehicle 100 may estimate a line connecting the neck and hip of the occupant in the third plane (x-z plane) based on the 3D human body keypoints and may estimate an angle between the estimated neck-hip line and the second reference line. The second reference line may be perpendicular to the ground. According to the exemplary embodiment of the present disclosure, the neck-hip line of the occupant may be obtained based on a keypoint corresponding to the neck and one or more keypoints corresponding to the hip among the human body keypoints estimated in step 901. For example, as shown in FIG. 9B, the neck-hip line of the occupant may be determined as a line connecting the keypoint 921 corresponding to the neck and any one of the one or more keypoints 821 and 823 corresponding to the hip. For another example, the neck-hip line of the occupant may be determined as a line connecting the keypoint 921 corresponding to the neck and the center point of the two keypoints 821 and 823 corresponding to the hip.

In step 905, the vehicle 100 may be configured to determine the estimated angle as the tilt of the upper body of the occupant. For example, as shown in FIG. 9B, the vehicle 100 may be configured to determine the estimated angle as an angle 931 at which the upper body of the occupant tilts.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle for protecting an occupant, the vehicle comprising:
a plurality of safe devices provided in the vehicle for protecting the occupant;
first sensors configured to obtain information on a seat or the occupant within the vehicle;
second sensors configured to detect a collision of the vehicle with objects; and
a processor which is operatively connected to the safe devices, the first sensors, and the second sensors,
wherein the processor is configured to:
obtain state information on at least one of the seat or the occupant based on the information obtained from the first sensors,
determine at least one safe device to be operated among the plurality of safe devices based on the state information on the at least one of the seat or the occupant, and
operate the determined at least one safe device when at least one of the second sensors detects the collision satisfying a predetermined condition, and
wherein the state information on the at least one of the seat or the occupant includes at least one of a rotation angle of the seat, a position of the seat, a tilt of the seat, a rotation angle of the occupant, a position of the occupant, and a tilt of the occupant.

2. The vehicle of claim 1, wherein the plurality of safe devices includes at least one of a plurality of airbags provided at different positions within the vehicle, and a plurality of pre-safe seat belts (PSBs) provided in different seats in the vehicle.

3. The vehicle of claim 1, wherein the processor is further configured to:
determine an operation threshold of the at least one safety device to be operated based on the state information on the at least one of the seat or the occupant,
compare an impact strength detected from at least one of the second sensors with the operation threshold, and
operate the determined at least one safety device when the detected impact strength is greater than the operation threshold.

4. The vehicle of claim 1, wherein the first sensors include at least one of a sensor configured to detect the rotation angle of the seat, a sensor configured to detect the position of the seat, or a sensor configured to detect the tilt of the seat.

5. The vehicle of claim 1,
wherein the first sensors include a camera configured to capture the occupant, and
wherein the processor is further configured to:
extract three-dimensional (3D) human body keypoints from an image captured by the camera by use of an artificial neural network-based deep learning model, and
obtain the state information on the occupant based on the extracted 3D human body keypoints.

6. The vehicle of claim 5, wherein the deep learning model is trained based on a new 3D body joint coordinate true which is generated by transforming a 3D body joint coordinate truth value.

7. The vehicle of claim 6, wherein the processor is further configured to:
estimate a first rotation angle between a predetermined first reference line and a shoulder line in an x-y plane based on the 3D human body keypoints, and
determine the first rotation angle as the rotation angle of the occupant, and
wherein the predetermined first reference line is set parallel to the shoulder line when a body of the occupant faces a front of the vehicle.

8. The vehicle of claim 6, wherein the processor is further configured to:
estimate a second rotation angle based on the 3D human body keypoints based on a width and a height of a body in a y-z plane, and
determine the second rotation angle as the rotation angle of the occupant.

9. The vehicle of claim 6, wherein the processor is further configured to:
estimate a first rotation angle between a predetermined first reference line and a shoulder line in an x-y plane based on the 3D human body keypoints,
estimate a second rotation angle based on the 3D human body keypoints based on a width and a height of a body in a y-z plane, and
determine the rotation angle of the occupant based on the first rotation angle and the second rotation angle.

10. The vehicle of claim 6, wherein the processor is further configured to:
measure a distance to a keypoint corresponding to a predetermined body portion among the 3D human body keypoints, and
determine the position of the occupant based on the measured distance.

11. The vehicle of claim 6,
wherein the processor is further configured to:
estimate an angle between a predetermined second reference line and a line connecting keypoints corresponding to a predetermined body portion among the 3D human body keypoints, and
determine the estimated angle as the tilt of the occupant, and
wherein the predetermined second reference line is perpendicular to the ground.

12. An operating method of a vehicle for protecting an occupant, the operating method comprising:
obtaining, by a processor, state information on at least one of a seat or the occupant within the vehicle based on information obtained from first sensors;
determining, by the processor, at least one safe device to be operated among a plurality of safe devices provided in the vehicle based on the state information on the at least one of the seat or the occupant; and
operating, by the processor, the determined at least one safe device when at least one of second sensors detects a collision of the vehicle satisfying a predetermined condition,
wherein the state information on the at least one of the seat or the occupant includes at least one of a rotation angle of the seat, a position of the seat, a tilt of the seat, a rotation angle of the occupant, a position of the occupant, and a tilt of the occupant.

13. The operating method of claim 12, wherein the plurality of safe devices includes at least one of a plurality of airbags provided at different positions within the vehicle, and a plurality of pre-safe seat belts (PSBs) provided in different seats in the vehicle.

14. The operating method of claim 12,
wherein the operating the determined at least one safe device includes:
comparing an impact strength detected from at least one of the second sensors with an operation threshold of the at least one safety device; and
operating the determined at least one safety device when the detected impact strength is greater than the operation threshold of the at least one safety device, and
wherein the operation threshold of the at least one safety device is determined based on the state information on the at least one of the seat or the occupant.

15. The operating method of claim 12, wherein the first sensors include at least one of a sensor configured to detect the rotation angle of the seat, a sensor configured to detect the position of the seat, or a sensor configured to detect the tilt of the seat.

16. The operating method of claim 12,
wherein the first sensors include a camera configured to capture the occupant, and
wherein the obtaining the state information on the at least one of the seat or the occupant includes:
extracting three-dimensional (3D) human body keypoints from an image captured by the camera by use of an artificial neural network-based deep learning model; and
obtaining the state information on the occupant based on the extracted 3D human body keypoints.

17. The operating method of claim 16, wherein the deep learning model is trained based on a new 3D body joint coordinate true which is generated by transforming a 3D body joint coordinate truth value.

18. The operating method of claim 17,
wherein the obtaining the state information on the occupant based on the extracted 3D human body keypoints includes:
estimating a first rotation angle between a predetermined first reference line and a shoulder line in an x-y plane based on the 3D human body keypoints; and
determining the first rotation angle as the rotation angle of the occupant, and wherein the predetermined first reference line is set parallel to the shoulder line when a body of the occupant faces a front of the vehicle.

19. The operating method of claim 17,
wherein the obtaining the state information on the occupant based on the extracted 3D human body keypoints includes:
estimating a second rotation angle based on the 3D human body keypoints based on a width and a height of a body in a y-z plane; and
determining the second rotation angle as the rotation angle of the occupant.

20. The operating method of claim 17,
wherein the obtaining the state information on the occupant based on the extracted 3D human body keypoints includes:
estimating a first rotation angle between a predetermined first reference line and a shoulder line in an x-y plane based on the 3D human body keypoints;
estimating a second rotation angle based on the 3D human body keypoints based on a width and a height of a body in a y-z plane; and
determining the rotation angle of the occupant based on the first rotation angle and the second rotation angle.

21. The operating method of claim 17,
wherein the obtaining the state information on the occupant based on the extracted 3D human body keypoints includes:
measuring a distance to a keypoint corresponding to a predetermined body portion among the 3D human body keypoints; and
determining the position of the occupant based on the measured distance.

22. The operating method of claim 17,
wherein the obtaining the state information on the occupant based on the extracted 3D human body keypoints includes:
estimating an angle between a predetermined second reference line and a line connecting keypoints corresponding to a predetermined body portion among the 3D human body keypoints; and
determining the estimated angle as the tilt of the occupant, and
wherein the predetermined second reference line is perpendicular to the ground.
